(19) United States
(12) Patent Application Publication
(10) Pub. No.: US 2013/0262243 A1
(43) Pub. Date: Oct. 3, 2013

(54) SOCIALIZED DEALS AND COUPONS

(71) Applicants: Nitin Motgi, Santa Clara, CA (US); Amit Motgi, Santa Clara, CA (US); Bruce Ng, Santa Clara, CA (US)

(72) Inventors: Nitin Motgi, Santa Clara, CA (US); Amit Motgi, Santa Clara, CA (US); Bruce Ng, Santa Clara, CA (US)

(73) Assignee: YAHOO! INC., Sunnyvale, CA (US)

(21) Appl. No.: 13/436,735

(22) Filed: Mar. 30, 2012

(51) Int. Cl. G06Q 30/02

(52) U.S. Cl. 705/14.73

(57) ABSTRACT

Techniques for socialized commercial incentives are provided. A commercial incentive is displayed in a page displayed by a browser. A user interface element is displayed in association with the commercial incentive that enables a function to be performed with respect to the commercial incentive. The user interface element is determined to have been interacted with by a user. In response, the function associated with the commercial incentive is performed. The function may be a saving of the commercial incentive to a list of commercial incentives for the user, a displaying of the list of commercial incentives, a generating of a digitized version of the commercial incentive, or may be another function.

### BACKGROUND OF THE INVENTION

1. Field of the Invention

The present invention relates to online deals and incentives.

2. Background

For many years, customers have been able to shop for products and services. Traditionally, a customer has been able to purchase a product or service from a merchant. The merchant may occasionally offer deals and/or coupons providing discounts on their products and/or services. Such deals and coupons may benefit customers with lower prices, and may benefit merchants by enabling increased sales volumes, enabling excess inventory to be reduced, and providing further benefits.

Online Advertising relates to the promoting of products and services using the Internet and World Wide Web. Typical online advertisement types include banner ads, floating ads, pop-up ads, and video ads which are provided through a browser to the user's computer desktop. Typically, online advertisement strategy involves placing an advertisement on the computer desktop of as many computer users as possible, in the hopes that at least a few computer users will be interested.

In some cases, merchants may provide deals and/or coupons that are displayed to users in a web page similarly to online advertisements. Users that view them may partake in the deals and/or coupons, if desired. However, once a user navigates away from a web page displaying a deal or coupon, they typically lose access to the deal or coupon. For instance, if the user attempts to return to the same web page, the user will not likely be presented with the same deal or coupon, and therefore will have lost the opportunity to access the deal or coupon. Additionally, users are not enabled to easily share deals and/or coupons with other users.

### BRIEF SUMMARY OF THE INVENTION

Various approaches are described herein for, among other things, for socializing online commercial incentives, such as deals and coupons. A commercial incentive of interest may be saved by a user to a list of commercial incentives for future viewing by the user. After saving the commercial incentive, the user is enabled to view the list of commercial incentives, to share commercial incentive in the list with a network of the user's friends, and to have conversations around the commercial incentives. Conversations between friends of the user in a social network regarding a commercial incentive may be displayed and interacted with by the user.

In one method implementation, a commercial incentive is displayed in a page displayed by a browser. A user interface element is displayed in association with the commercial incentive that enables a function to be performed with respect to the commercial incentive. The user interface element may be determined to have been interacted with by a user. In response, the function associated with the commercial incentive is performed. The function may be a saving of the commercial incentive to a list of commercial incentives for the user, a displaying of the list of commercial incentives, a generating of a digitized version of the commercial incentive, or may be another function.

In a system implementation, a commercial incentive socializing system includes a content serving module, a page monitor, and a commercial incentive tracker. The content serving module provides a page to a computing device for display in a browser. The page includes a commercial incentive and a user interface element positioned in association with the commercial incentive that enables the commercial incentive to be saved. The page monitor determines when the user interface element displayed by the browser in the page has been interacted with by a user. In response, the commercial incentive tracker saves an indication of the commercial incentive in a user profile of the user. The user profile may include a list of commercial incentives.

The commercial incentive tracker may include a message generator. The message generator generates a message regarding the commercial incentive that is provided to at least one friend of the user in a social network.

The system may further include a commercial incentive list display module. The page may further include a second user interface element positioned in association with the displayed commercial incentive that enables the list of commercial incentives to be displayed. When the page monitor determines that the second user interface element has been interacted with, the commercial incentive list display module causes the list of commercial incentives to be displayed.

Furthermore, if the page monitor receives an indication of an interaction with the information displayed for a commercial incentive in the list of commercial incentives, the commercial incentive list display module enables a conversations interface to be displayed. The conversations interface includes a plurality of messages associated with the commercial incentive sent by the friends of the user. The conversation interface may also include a user interface element configured to enable the user to send a message to the friends of the user.

The system may further include a digital object generator. The page may further include a third user interface element positioned in association with the displayed commercial incentive that enables a digital format version of the commercial incentive to be provided to the user. When the page monitor determines that the third user interface element has been interacted with, the digital object generator generates the digital format version of the commercial incentive. The digital format version of the commercial incentive is transmitted to the user.

Computer program products are also described herein that enable users to save online commercial incentives to a list, to display a list of commercial incentives, to share online commercial incentives, and to converse with other users about online commercial incentives, as well as enabling further embodiments described herein.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows a block diagram of a communication system for offering and socializing commercial incentives, according to an example embodiment.

FIG. 2 shows a flowchart providing a process for enabling users to interact with commercial incentives, including enabling the users to save, share, and communicate about commercial incentives, according to an example embodiment.

FIG. 3 shows a block diagram of a commercial incentive (CI) socializing system, according to an example embodiment.

FIG. 4 shows a flowchart providing a process for enabling a user to save a commercial incentive to a user profile of the user, according to an example embodiment.

FIG. 5 shows a block diagram of a commercial incentive displayed in a page by a browser, according to an example embodiment.

FIG. 6 shows a block diagram of a commercial incentive tracker configured to generate messages regarding commercial incentives, according to an example embodiment.

FIG. 7 shows a flowchart providing a process for displaying a list of commercial incentives associated with a user, according to an example embodiment.

FIG. 8 shows a block diagram of a list of commercial incentives being displayed, according to an example embodiment.

FIG. 9 shows a flowchart providing a process for displaying a commercial incentive in a list of commercial incentives associated with a user, according to an example embodiment.

FIG. 10 shows a flowchart providing a process for displaying a conversation occurring with respect to a commercial incentive, according to an example embodiment.

FIG. 11 shows a block diagram of a commercial incentive list display module configured to display conversations regarding commercial incentives, according to an example embodiment.

FIG. 12 shows a block diagram of a conversations interface being displayed with a list of commercial incentives, according to an example embodiment.

FIG. 13 shows a flowchart providing a process for generating a transportable version of a commercial incentive, according to an example embodiment.

FIG. 14 is a block diagram of a computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### II. Example Embodiments

A deal is an offer of a financial discount, rebate, or other incentive for purchasing a product and/or a service (or multiple products and/or services) that may be accepted by a customer. A coupon is a document (paper or electronic) that can be exchanged for a financial discount, rebate, or other incentive when a customer is purchasing a product and/or a service (or multiple products and/or services). Deals and coupons are examples of commercial incentives, which are incentives (e.g., financial discounts, rebates, etc.) that may be provided by merchants to encourage customers to purchase products and/or services.

Merchants may provide commercial incentives that are displayed to users in a web page in a similar manner to online advertisements. Users that view the commercial incentive may partake in the commercial incentive, if desired. For example, a user may present a coupon of the commercial incentive to a merchant (in person or online), may click on (or otherwise select) a link that navigates the user to a graphical user interface (GUI) for the discount provided online by a merchant, and/or may partake in a commercial incentive in other ways.

Currently web pages are very dynamic, as the displayed content changes frequently on multiple viewings. Sometimes a user viewing content of a web page that includes a commercial incentive may desire to follow several paths on the page, including following links to other content. After the user navigates away from the page, if the user attempts to return to the same web page to view the commercial incentive again, the user will not likely be presented with the same commercial incentive. As such, the user will have lost the opportunity to access the commercial incentive.

Additionally, users are not enabled to easily share commercial incentive with other users. For instance, when a user sees a commercial incentive on a web page that his or her friend may be interested in, it is not easy for the user to share the commercial incentive with their friends. Moreover, as commercial incentives become more engaging, users may want to save and share particularly interesting commercial incentives, and may desire to have conversations around them.

Embodiments enable users to save a commercial incentive for future viewing to use/share. After saving the commercial incentive, the user is enabled to share the commercial incentive with a network of their friends, and to have conversations around the commercial incentive. For instance, in an embodiment, conversations between friends of the user at social networks may be displayed and interacted with.

Embodiments provide new experiences around commercial incentives for users by enabling the users to save, list, and share commercial incentives. Embodiments enable users to have filtered conversations with friends in social network around the commercial incentives. Embodiments enable users to manage a list of commercial incentives. In an embodiment, conversations between friends of the user discussing a commercial incentive that the user has saved may be displayed.

For example, in an embodiment, a user may read an article on a news website, and on the same web page, may view a deal on a new Ford automobile. The user may be provided an option to save a link for the deal. The user may optionally view a list of previously saved coupons/deals for the user. In the list view, the user may be enabled to view which of his/her friends are talking about a particular products or a deal, such as friends discussing the new Ford car. The user may delete a link for a particular commercial incentive from the list of saved commercial incentives if no longer interested in the commercial incentive.

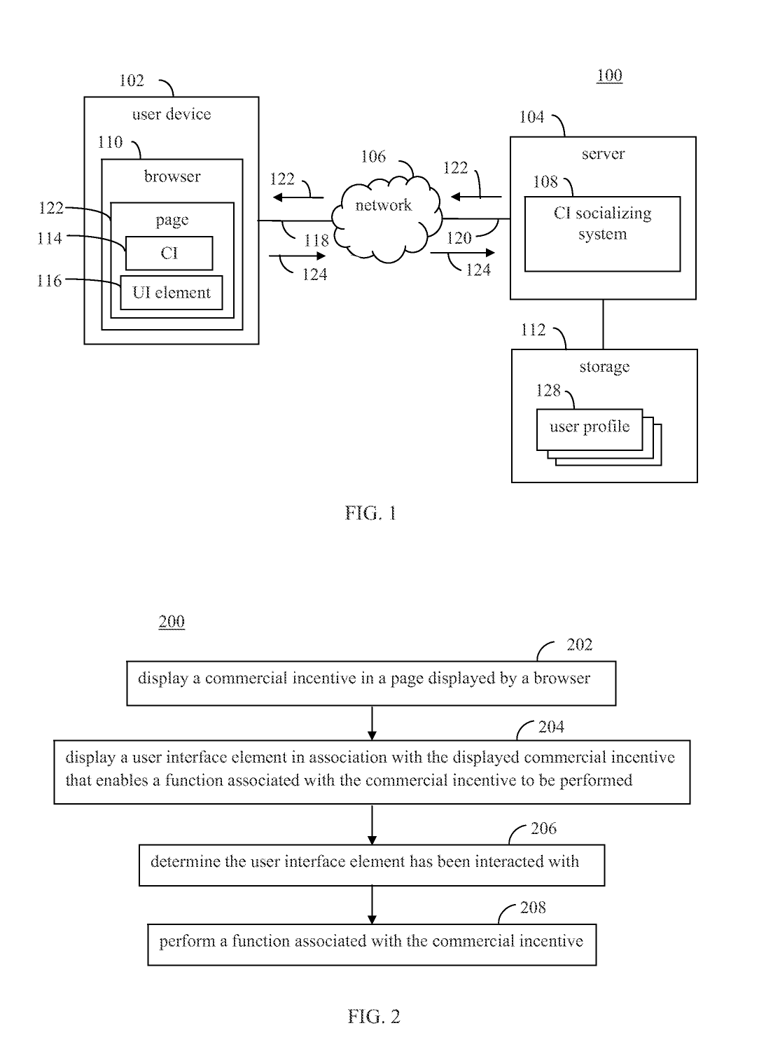

Embodiments may be implemented in a variety of environments. For instance, FIG. 1 shows a block diagram of a communication system 100 in which commercial incentives may be offered and socialized, according to an example embodiment. Environment 100 is shown for purposes of illustration, and embodiments may be implemented in other environments, as would be apparent to persons skilled in the relevant art(s) from the teachings herein. As shown in FIG. 1, system 100 includes a user device 102, a server 104, and a network 106. Furthermore, as shown in FIG. 1, storage 112 is coupled to server 104. System 100 is described as follows.

User device 102 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a smart phone (e.g., an Apple iPhone, a Google Android™ phone, a Microsoft Windows® phone, etc.), or other type of computing device. Server 104 may be implemented in one or more computer systems, including one or more servers, which may be any type of computing device described herein or otherwise known that is capable of enabling the corresponding functionality described herein.

User device 102 and server 104 are communicatively coupled with each other through network 106. Network 106 may be a LAN (local area network), a WAN (wide area network), or any combination of networks, such as the Internet. User device 102 is coupled with network 106 through a communication link 118, and server 104 is coupled with network 106 by communication link 120. Communication links 118 and 120 may each include wired and/or wireless links. Examples of communication links 118a-118n and 120 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Network 106 may include one or more routers, hubs, switches, bridges, etc., used to connect devices/networks and/or to forward data (e.g., data packets). In embodiments, network 106 may include the Internet and/or an intranet. Network 106 may enable RF (radio frequency) or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

When signals are transmitted in signal packets in network 106, such signal packets may be compatible with or compliant with one or more protocols. Signaling formats or protocols employed may include, for example, TCP/IP, UDP, DECnet, NetBEUI, IPX, Appletalk, or the like. Example versions of the Internet Protocol (IP) may include IPv4 or IPv6.

As shown in FIG. 1, storage 112 stores a plurality of user profiles, including a user profile 128. User profile 128 is a collection of information for a particular user, including personal information such as login information, user attributes (e.g., demographic information, user preferences, etc.), and/or further information regarding the user. User profile 128 may be associated with one or more accounts of the user, such as a website account, an email account, a social network account, etc.

Storage 112 may each include one or more of any type of storage mechanism to store resources, including a magnetic disk (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Server 104 may optionally be a content server that serves various forms of content. As shown in FIG. 1, server 104 includes a commercial incentive (CI) socializing system 108. CI socializing system 108 is configured to enable various functions with regard to commercial incentives, including one or more of enabling commercial incentives to be saved to a user profile, to be shared by users with other users, and to be saved into a portable format.

In embodiments, CI socializing system 108 may operate in various ways to perform its functions. For instance, FIG. 2 shows a flowchart 200 providing a process for enabling users to interact with commercial incentives, including enabling the users to save, share, and communicate about commercial incentives, according to an example embodiment. In an embodiment, user device 102, server 104, and CI socializing system 108 may operate according to flowchart 200. Further structural and operational embodiments will be apparent to persons skilled in the relevant art(s) based on the following description of flowchart 200.

Flowchart 200 begins with step 202. In step 202, a commercial incentive is displayed in a page displayed by a browser. For instance, as shown in FIG. 1, a user at user device 102 may interact with browser 110 to view a web page. Browser 110 may be any type of application that enables web pages to be displayed and viewed, including a web browser (e.g., Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., Google® Chrome of Mountain View, Calif., etc.), an “app” at a mobile device that includes functionality for viewing web pages, and any other type of application that provides browser functionality. The user may interact with browser 110 to request to view page 122. For instance, the user may type in a link (e.g., uniform resource locator (URL)) for page 122, may click on a link for page 122, or may otherwise attempt to navigate to page 122.

Accordingly, browser 110 may transmit a request (not shown in FIG. 1) for page 122 that is received by server 104 (or by other server) in a communication signal. In response, server 104 (or other server, such as a content server) may transmit page 122 to browser 110 at user device 102 in a communication signal through network 106. As shown in FIG. 1, a commercial incentive (CI) 114 may be displayed by browser 110 in page 122 (along with further content, optionally). For example, browser 110 may transmit a request (not shown in FIG. 1) for CI 114 based on a link present in page 122. In response, server 104 (or other server, such as an ad server) may transmit CI 114 to browser 110 at user device 102 in a communication signal through network 106.

CI 114 is a commercial incentive providing a deal, coupon, or other type of commercial incentive to the user of user device 102. CI 114 may optionally include one or more images, and may include text (in or outside of an image) that provides information regarding the commercial incentive, such as an identification of one or more products and/or services being offered, an identification of an entity offering the products/services, price information, deal information (e.g., a discount, a rebate, etc.), a coupon, etc.

Referring back to FIG. 2, in step 204, a user interface element is displayed in association with the displayed commercial incentive that enables a function associated with the commercial incentive to be performed. For example, as shown in FIG. 1, a user interface (UI) element 116 is displayed in page 122. UI element 116 may be included in CI 114 or may be separate from CI 114 and defined in page 122. UI element 116 is a user interface element that a user may interact with to cause a function to be performed with respect to CI 114. UI element 116 may be any type of suitable graphical user interface element, such as a button, a pull down menu, a pop-up menu, a radio button, etc. UI element 116 may include text or other indication of its functionality (e.g., “Save This”, “List”, “Digit Me”, etc.).

In step 206, the user interface element is determined to have been interacted with. A user of user device 102 may interact with UI element 116 to invoke functionality associated with CI 114. The user may interact with UI element 116 in any manner, such as by using a keyboard, a thumb wheel, a pointing device, a roller ball, a stick pointer, a touch sensitive display, a voice recognition system, etc. For instance, when UI element 116 is a graphical button, the user may click on the button using a mouse pointing device to invoke the functionality associated with CI 114. An indication of the interaction with UI element 116 may be detected in browser 110, and transmitted from user device 102 as interaction indication 124 in a communication signal to CI socializing system 108 at server 104 through network 106.

In step 208, a function associated with the commercial incentive is performed. In an embodiment, in response to UI element 116 being interacted with, and interaction indication 124 being received, CI socializing system 108 may perform a function. For example, as further described below, CI socializing system 108 may store an indication of CI 114 in a list of commercial incentives for the user (e.g., in user profile 128 in storage 112), may display the list of commercial incentives, may generate a savable format version of CI 114, and/or may perform other function with respect to CI 114.

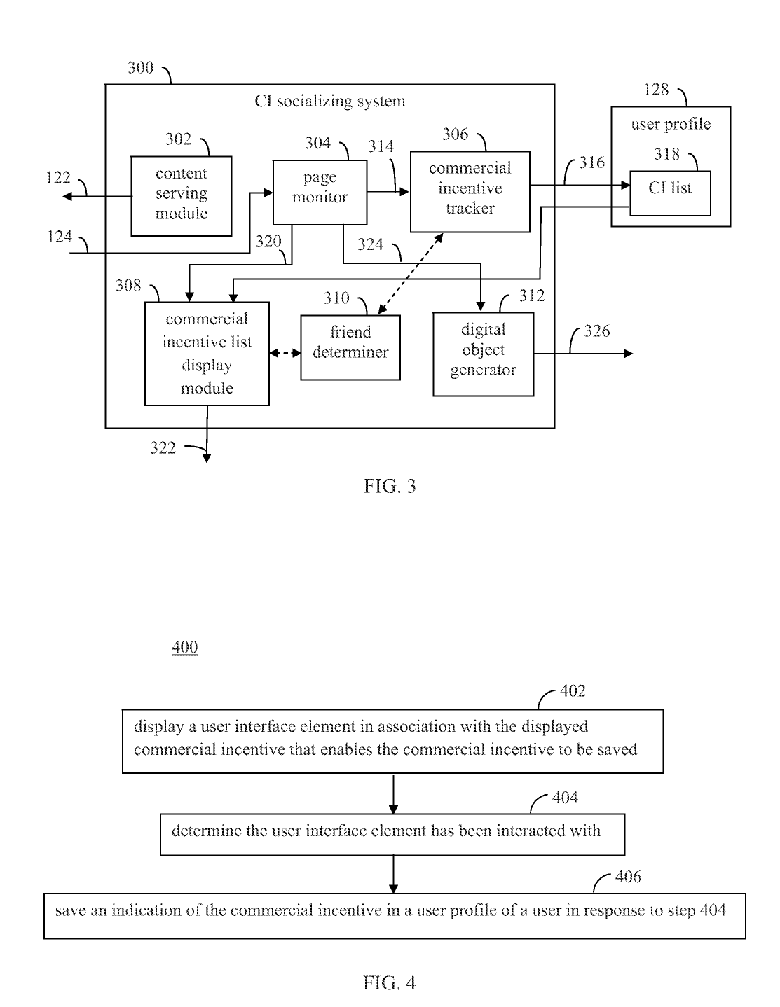

CI socializing system 108 may be configured in various ways to perform its functions. For instance, FIG. 3 shows a block diagram of a CI socializing system 300, according to an example embodiment. CI socializing system 300 is an example of CI socializing system 108 of FIG. 1. As shown in FIG. 3, CI socializing system 300 includes a content serving module 302, a page monitor 304, a commercial incentive tracker 306, a commercial incentive list display module 308, a friend determiner 310, and a digital object generator 312. CI socializing system 300 is described as follows. It is noted that CI socializing system 300 is provided for purposes of illustration, and is not intended to be limiting. In some embodiments, not all elements of CI socializing system 300 need be present.

Content serving module 302 is optionally present in CI socializing system 300, or may be present elsewhere in server 104 (FIG. 1), or in a different server. When present, content serving module 302 is configured to serve content to user devices, such as user device 102 shown in FIG. 1. For instance, as shown in FIG. 1, content serving module 302 may store (e.g., in storage 112) and serve web pages, such as page 122 and optionally further types of content. Furthermore, content serving module 302 (or a different server) may store and serve commercial incentives, such as CI 114.

Page monitor 304 is configured to detect interactions with user interface elements associated with commercial incentives. Commercial incentive tracker 306 is configured to maintain a list of saved commercial incentives for users. Commercial incentive list display module 308 is configured to provide a list of commercial incentives for a user upon request. Friend determiner 310 is configured to determine friends of users. Digital object generator 312 is configured to generate savable and transportable representations of displayed commercial incentives upon request.

Further details of the elements of CI socializing system 300 are described in the following subsections, as well as further embodiments for flowchart 200 of FIG. 2 and CI socializing system 108 of FIG. 1.

### A. Example Embodiments for Generating a List of Commercial Incentives

As described above, in an embodiment, a user may be enabled to save commercial incentives that the user views in web pages. The user may save the commercial incentives into a list of commercial incentives linked with the user. In this manner, the user may be able to keep track of commercial incentives of interest, share commercial incentives with users, converse about commercial incentives with other users, and perform other activities related to commercial incentives.

For instance, FIG. 4 shows a flowchart 400 providing a process for enabling a user to save a commercial incentive to a user profile of the user, according to an example embodiment. Flowchart 400 is an example embodiment of flowchart 200 of FIG. 2. In an embodiment, CI socializing system 108 of FIG. 1 and CI socializing system 300 of FIG. 3 may each operate according to flowchart 400. Further structural and operational embodiments will be apparent to persons skilled in the relevant art(s) based on the following description of flowchart 400.

Flowchart 400 begins with step 402. In step 402, a user interface element is displayed in association with the displayed commercial incentive that enables the commercial incentive to be saved. As described above with respect to step 202 of FIG. 2, CI 114 may be displayed in page 122. Furthermore, as described with respect to step 204 of FIG. 2, UI element 116 may be displayed in association with CI 114. For instance, UI element 116 may be displayed within a boundary of CI 114 or may be displayed outside of CI 114, including being displayed next to a right side, next to a left side, over a top side, or below a bottom side of CI 114.

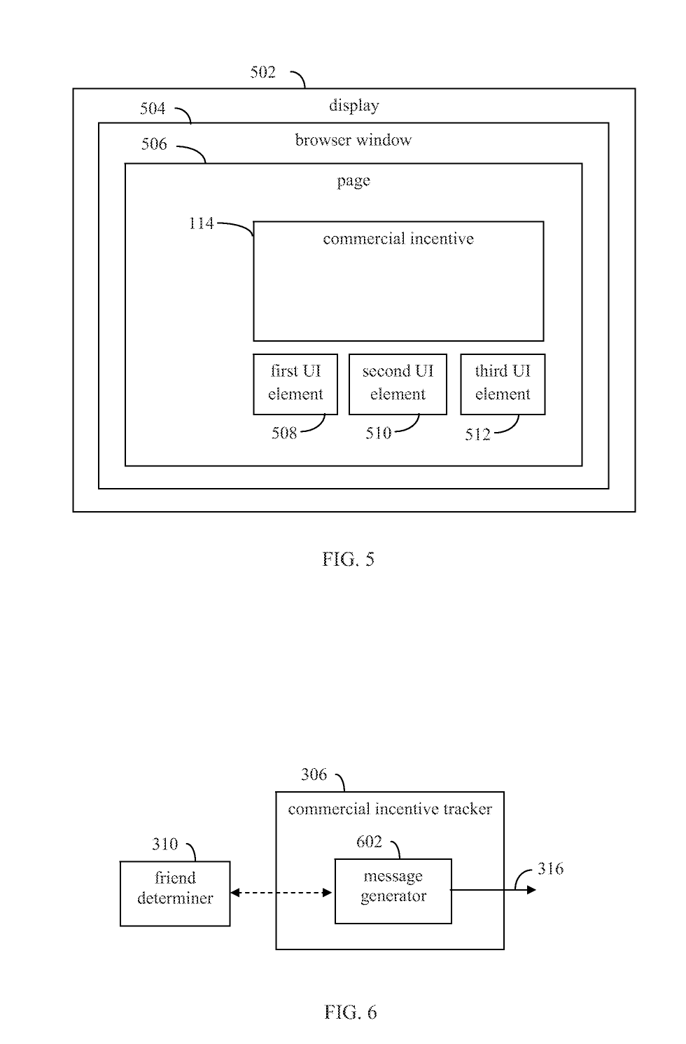

FIG. 5 shows a block diagram of CI 114 being displayed by a display 502, according to an example embodiment. As shown in FIG. 5, a browser window 504 is displayed by display 502, which includes a web page 506 in which CI 114 resides. Furthermore, first-third UI elements 508, 510, and 512 are displayed in page 506 in association with CI 114 (e.g., being displayed below CI 114 in this example). Further content (not shown in FIG. 5) may be displayed in page 506. Page 506 is an example of page 122 of FIG. 1, and first-third UI elements 508, 510, and 512 are each an example of UI element 116 of FIG. 1. Each of first-third UI elements 508, 510, and 512 may be interacted with by a user to cause corresponding functionality related to CI 114 to be performed.

For instance, according to step 402 of FIG. 4, UI element 508 may be configured to enable CI 114 to be saved for a user. For instance, when a user interacts with UI element 508, CI 114 may be saved to a list of commercial incentives for the user. In an embodiment, UI element 508 may have a corresponding label, such as the text “Save”, “Save This,” or other suitable label.

Display 502 may be any type of display mentioned elsewhere herein or otherwise known, including an LCD (liquid crystal display), an LED (light emitting diode), a plasma display, a CRT (cathode ray tube) display, etc.

Referring back to FIG. 4, in step 404, the user interface element is determined to have been interacted with. UI element 508 may be configured in various ways, and the user may interact with UI element 508 in any suitable manner (e.g., as described with respect to UI element 116 elsewhere herein). An indication of the interaction with UI element 508 may be detected in browser window 504, and as shown in FIG. 1, transmitted from user device 102 to CI socializing system 108 as interaction indication 124. As shown in FIG. 3, page monitor 304 may receive interaction indication 124, and in response may generate a save instruction 314.

In step 406, an indication of the commercial incentive is saved in a user profile of a user in response to step 404. As described above with respect to step 208 of FIG. 2, CI socializing system 108 may save CI 114 in response to UI element 116 being interacted with. Referring to FIG. 3, commercial incentive tracker 306 may receive save instruction 314 from page monitor 304, which instructs commercial incentive tracker 306 to store an indication of CI 114 in a list of commercial incentives for the user. In response, commercial incentive tracker 306 may retrieve CI 114 from content serving module 302 (or directly from associated storage). As shown in FIG. 3, commercial incentive tracker 306 generates commercial incentive indication 316, which includes information of CI 114. For instance, commercial incentive indication 316 may include one or more of an image of CI 114, a link associated with CI 114 (e.g., a link to the entity providing CI 114, a link that enables the commercial incentive to be accepted by the user, etc.), information regarding a deal or a coupon associated with CI 114, etc. As shown in FIG. 3, commercial incentive tracker 306 stores commercial incentive indication 316 in a CI list 318 in user profile 128 for the user. CI list 318 includes a list of one or more commercial incentives that the user has saved.

As such, in embodiments, a user is enabled to save information regarding commercial incentives to a list of commercial incentives for the user. The user can view the list of commercial incentives, can share the commercial incentives with other users, and can converse about the commercial incentives.

In an embodiment, a message regarding a saved commercial incentive may be automatically generated for a user that saved the commercial incentive to a list of commercial incentives. The message may be generated and transmitted from a user account of the user, such as a user account associated with the user profile of the user (e.g., a user account that stores the user profile, or is linked to the user profile). The message may be transmitted to at least one friend of the user, such as users that are indicated as “friends” of the user in a social network.

For example, with respect to FIG. 5, a message regarding CI 114 may be generated when the user interacts with first UI element 508 to save CI 114 to the CI list of the user. In an embodiment, the message may be generated by commercial incentive tracker 306 of FIG. 3. For instance, FIG. 6 shows a block diagram of commercial incentive tracker 306 of FIG. 3, according to an example embodiment. As shown in FIG. 6, commercial incentive tracker 306 includes a message generator 602. Message generator 602 is configured to generate a message 316 that is descriptive of CI 114 when the user interacts with first UI element 508 to save CI 114 to the CI list. As shown in FIG. 6, message generator 602 may interact with friend determiner 310 to determine one or more users that are considered friends of the user. Friend determiner 310 may access one or more social network accounts associated with the user profile of the user to determine one or more users indicated as friends of the user in the social network(s). Message generator 602 may transmit message 316 to the determined one or more friends.

Friend determiner 310 may access any number of social network accounts to determine friends in any manner. For instance, with respect to some social networks, such as Facebook® operated by Facebook, Inc. of Palo Alto, Calif., and Google+ operated by Google, Inc. of Mountain View, Calif., “friends” may be explicitly indicated in the social network user account of the user (individually or in a “friends” group). In another example, with respect to the social network Twitter™ operated by Twitter, Inc. of San Francisco, Calif., friends may be implicitly indicated in the social network user account of the user—it may be assumed that users that the user follows and that also follow the user may be considered as “friends” of the user (because they have a two-way follow relationship). In further types of social networks, friends may be indicated in further ways, and determined by friend determiner 310 to be friends of a user.

Message 316 may have any suitable format. For instance, with respect to some social networks such as Facebook® and Google+, message 316 may be a message posting to a friends group or may be a message that is transmitted to each friend individually. With respect to some other social networks, such as Twitter™, message 316 may be a text message (e.g., a “tweet” in the case of Twitter™). In further types of social networks, message 316 may have other formats. Message 316 may include information regarding the commercial incentive, such as a link to the commercial incentive, a description of the particular product, service, deal, and/or coupon, etc. Message 316 may also include one or more tags associated with the commercial incentive. The included tag(s) may enable message 316 to be more easily located in a stream of messages (e.g., a message conversation) during a search, to find messages directed to a particular commercial incentive. For instance, in the example of Twitter™, a tweet regarding a commercial incentive may include one or more hash tags (a hash symbol “#” followed by tag text) to enable the tweet to be surfaced a next time a Twitter user invokes a CI list view. One or more words of the commercial incentive may be tagged in this manner, such as a name of the particular product/service, an entity (e.g., a company name, a person's name, etc.) providing the product/service, etc.

Note that in another embodiment, a user may cause a message regarding a commercial incentive to be generated when the user views the commercial incentive in a list of commercial incentives (as described in further detail in the following subsection).

### B. Example Embodiments for Displaying a List of Commercial Incentives

As described above, in an embodiment, a user may be enabled to view a list of saved commercial incentives. In this manner, the user may be able to keep track of commercial incentives of interest, share commercial incentives with users, converse about commercial incentives with other users, and perform other activities related to commercial incentives.

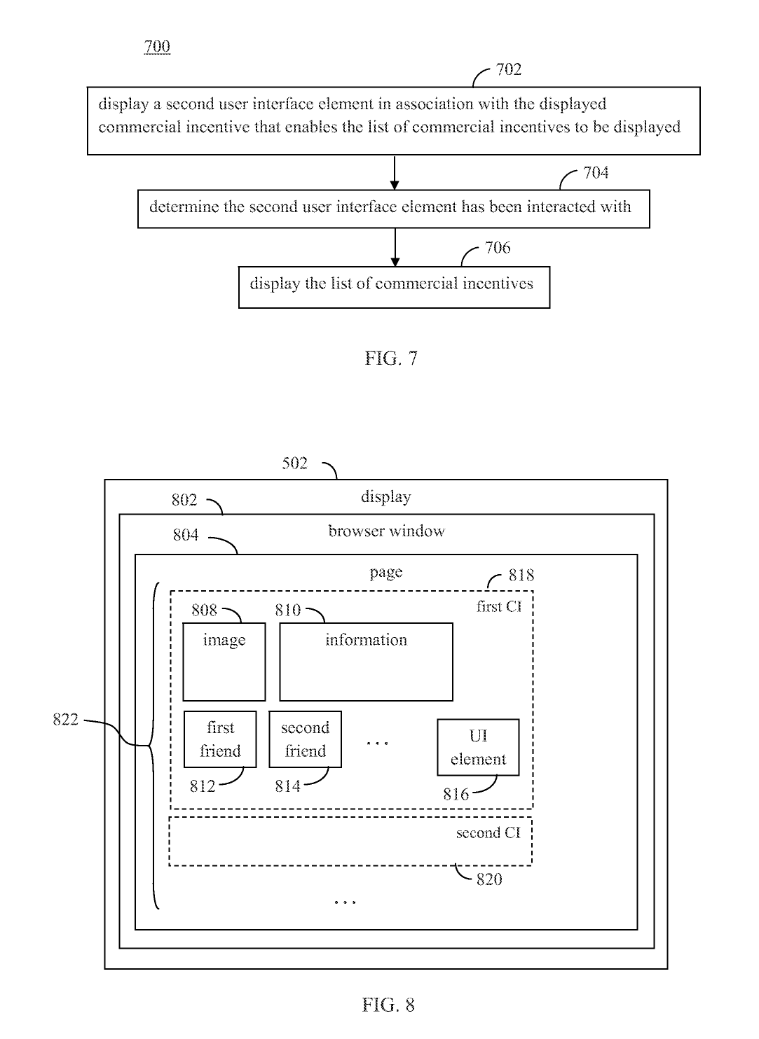

For instance, FIG. 7 shows a flowchart 700 providing a process for displaying a list of commercial incentives associated with a user, according to an example embodiment. Flowchart 700 is an example embodiment of flowchart 200 of FIG. 2. In an embodiment, CI socializing system 108 of FIG. 1 and CI socializing system 300 of FIG. 3 may each operate according to flowchart 700. Further structural and operational embodiments will be apparent to persons skilled in the relevant art(s) based on the following description of flowchart 700.

Flowchart 700 begins with step 702. In step 702, a second user interface element is displayed in association with the displayed commercial incentive that enables the list of commercial incentives to be displayed. As described above with respect to step 202 of FIG. 2, CI 114 may be displayed in page 122. Furthermore, as described with respect to step 204 of FIG. 2, UI element 116 may be displayed in association with CI 114. Referring to FIG. 5, second UI element 510 is displayed in page 506 in association with CI 114. According to step 702 of FIG. 7, UI element 510 may be configured to enable a list of saved commercial incentives to be displayed for a user. For instance, when a user interacts with UI element 510, the list of commercial incentives saved for the user may be displayed. In an embodiment, UI element 510 may have a corresponding label, such as the text “List”, “Display List,” or other suitable label.

In step 704, the second user interface element is determined to have been interacted with. UI element 510 may be configured in various ways, and the user may interact with UI element 510 in any suitable manner (e.g., as described with respect to UI element 116 elsewhere herein). An indication of the interaction with UI element 510 may be detected in browser window 504, and as shown in FIG. 1, may be transmitted from user device 102 to CI socializing system 108 as interaction indication 124. As shown in FIG. 3, page monitor 304 may receive interaction indication 124, and in response may generate a list instruction 320.

In step 706, the list of commercial incentives is displayed. As described above with respect to step 208 of FIG. 2, CI socializing system 108 may generate a list of commercial incentives in response to UI element 116 being interacted with. Referring to FIG. 3, commercial incentive list display module 308 may receive list instruction 320 from page monitor 304, which instructs commercial incentive list display module 308 to generate a list of commercial incentives to display for an identified user (the user having interacted with UI element 510 of FIG. 5). As shown in FIG. 3, commercial incentive list display module 308 may retrieve CI list 318 from user profile 128 of the user identified in list instruction 320. CI list 318 may store various information for each included commercial incentive (e.g., an image, a link, deal/coupon information, etc.) As shown in FIG. 3, commercial incentive list display module 308 may generate list display information 322, which includes information of CI list 318 to be provided to a display device to enable display of a commercial incentives list to the user. For instance, in FIG. 1, list display information 322 may be transmitted from server 104 to user device 102 to be displayed in browser 110.

The information of list display information 322 may be displayed in any manner. For instance, FIG. 8 shows a block diagram of a commercial incentives list 822 being displayed, according to an example embodiment. As shown in FIG. 8, a browser window 802 is displayed by display 502, which includes a page 804 in which CI list 822 resides. CI list 822 may optionally include a header that identifies CI list 822 (e.g., “Saved Coupons/Deals”, etc.). CI list 822 may include any number of listed commercial incentives. In the example of FIG. 8, a first CI 818 and a second CI 820 are included in CI list 822, and further commercial incentives may be present (but are not shown in FIG. 8 for ease of illustration).

Any amount of information may be shown for each commercial incentive displayed in CI list 822. For instance, as shown in FIG. 8, first CI 818 shown in CI list 822 includes the display of an image 808, information 810, a first friend 812, a second friend 814, and a UI element 816. Image 808 is an image associated with a product, a service, a deal, a coupon, and/or other aspect of CI 818. Image 808 may be used by users viewing CI 818 to quickly identify CI 818. Information 810 includes information (e.g., textual information) describing CI 818, such as a description of the service, product, deal, coupon, etc., offered by CI 818.

First and second friends 812 and 814 identify friends of the user, and any number of friends may be indicated in CI 818. For instance, in an embodiment, friends 812 and 814 may be friends that are identified as having messages/conversations in a social network about the service, product, deal, coupon, etc., offered by CI 818. Friends 812 and 814 may be determined by friend determiner 310 of FIG. 3, which may search a social network for messages/conversations about the service, product, deal, coupon, etc., of CI 818 (e.g., by filtering messages of the social network(s) using search keywords associated with CI 818) engaged in by friends of the user. Friends 812 and 814 may be indicated in CI 818 by respective images, account names, and/or other identifying information.

UI element 816 is a user interface element similar to other user interface elements described elsewhere herein that may be interacted with to cause CI 818 to be shared with one or more other users. For instance, when the user interacts with UI element 816, a message may be generated (e.g., message 316 generated by message generator 602 of FIG. 6) regarding CI 818 that is transmitted to identified friends of the user. In an embodiment, UI element 816 may have a corresponding label, such as the text “Share”, “Share This”, or other suitable label.

For example, CI 114 of FIG. 5 may show an offer of a deal for a new Ford car with a 0% APR (annual percentage rate). A user may have added this deal to their CI list. In such an example, CI 818 of FIG. 8 may show a representation of the deal, including showing an image of a Ford car as image 808, providing a description such as “Ford Launches New Supercar Deal with 0% APR” as information 810, and showing a pair of friends of the user that are discussing Ford (e.g., have used the search keyword “Ford” in their messages/conversations).

In another example, CI 114 of FIG. 5 may show a Safeway grocery store coupon. A user may have added this coupon to their CI list. In such an example, CI 818 of FIG. 8 may show a representation of the coupon, including showing an image of the coupon as image 808, providing a description such as “Safeway Food Coupons 50% Discount” as information 810, and showing a pair of friends of the user that are discussing Safeway (e.g., have used the search keyword “Safeway” in their messages/conversations).

In an embodiment, a representation of a commercial incentive displayed in CI list 822 of FIG. 8 may be generated according to FIG. 9. FIG. 9 shows a flowchart 900 providing a process for displaying a commercial incentive in a list of commercial incentives associated with a user, according to an example embodiment. Flowchart 900 is described as follows.

In step 902, information regarding the commercial incentive is displayed in the displayed list of commercial incentives. For instance, as shown in FIG. 8, image 808 and information 810 are displayed in CI 818. Image 808 and information 810 may have been extracted from CI 114 when saved to a commercial incentive list for the user.

In step 904, at least one friend of the user having mentioned an aspect of the commercial incentive in a social network content stream is determined. For example, as described above, one or more friends of the user may be determined by friend determiner 310 of FIG. 3, such as from one or more social networks associated with the user. Furthermore, friend determiner 310 may search for messages/conversations in content streams of the social network(s) that the determined friends have participated in about the service, product, deal, coupon, etc., of CI 818 (e.g., by filtering messages of the social network(s) using search keywords associated with CI 818).

In step 906, an indication of the determined at least one friend is displayed in association with the displayed information regarding the commercial incentive. In the example of FIG. 8, friends 812 and 814 may have been identified by friend determiner 310 as having provided messages regarding CI 818, and therefore may be displayed as friends of the user in CI 818, as shown in FIG. 8. Images of friends 812 and 814 may be displayed that are retrieved from social network user profiles for the friends 812 and 814, or from other sources.

As such, in embodiments, a user is enabled to generate a list of commercial incentives that are of interest to the user. The user can view the list of commercial incentives, can share the commercial incentives with other users, and can converse about the commercial incentives.

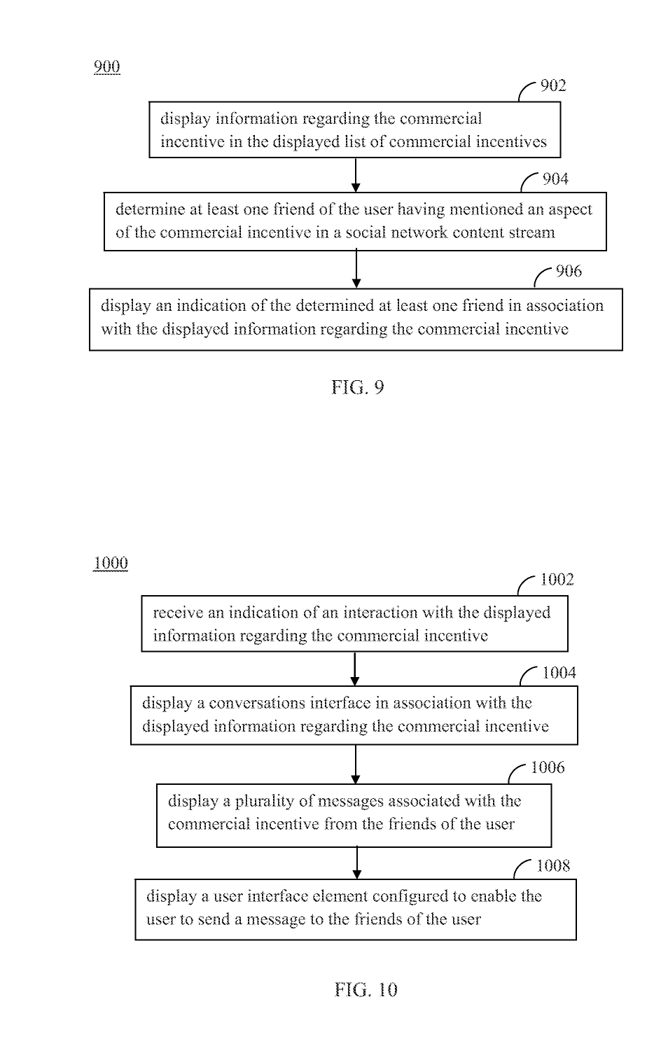

Conversations about the commercial incentives may be enabled in any manner by interacting with commercial incentive lists. For instance, FIG. 10 shows a flowchart 1000 providing a process for enabling conversations with respect to a commercial incentive, according to an example embodiment. In an embodiment, commercial incentive list display module 308 of FIG. 3 may operate according to flowchart 1000. Flowchart 1000 is described with respect to FIG. 11 for purposes of illustration. FIG. 11 shows a block diagram of commercial incentive list display module 308 configured to display conversations regarding commercial incentives, according to an example embodiment. As shown in FIG. 11, commercial incentive list display module 308 includes a conversation interface generator 1102. Further structural and operational embodiments will be apparent to persons skilled in the relevant art(s) based on the following description of flowchart 1000.

Flowchart 1000 begins with step 1002. In step 1002, an indication is received of an interaction with the displayed information regarding the commercial incentive. For example, referring to FIG. 8, a user may interact with the displayed information of a commercial incentive in CI list 822, such as CI 818. For instance, the user may click within the boundaries of CI 818, may hover a pointer over CI 818, or may interact with CI 818 in other manner. An indication of the interaction with CI 818 may be detected in browser window 802, and transmitted from user device 102 in a communication signal to CI socializing system 108 at server 104 through network 106 (FIG. 1).

In step 1004, a conversations interface is displayed in association with the displayed information regarding the commercial incentive. As shown in FIG. 11, conversation interface generator 1102 may receive an interaction indication 1104, indicating that the user interacted with CI 818. In response to receiving interaction indication 1104, conversation interface generator 1102 may generate conversations display information 1106, which includes information of conversations associated with CI 818 to be provided to a display device to enable display of the conversations. For instance, in FIG. 1, conversations display information 1106 may be transmitted from server 104 to user device 102 to be displayed in browser 110.

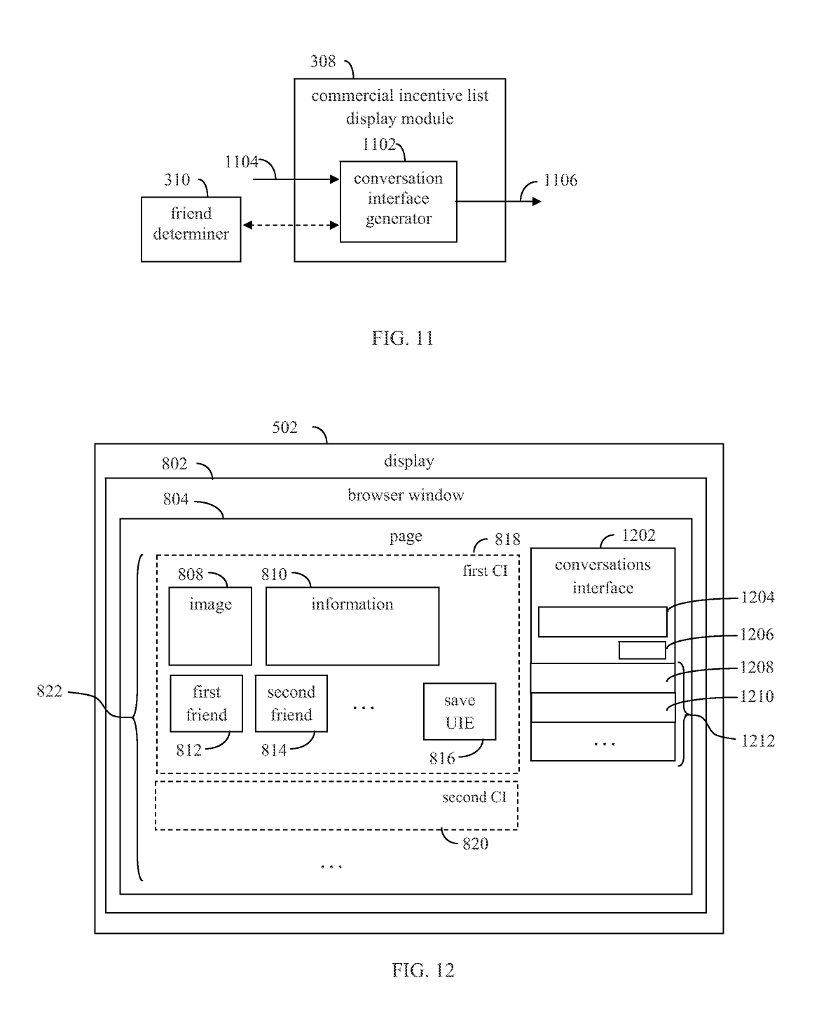

The information of conversations display information 1106 may be displayed in any manner. For instance, FIG. 12 shows a block diagram of a conversations interface 1202 being displayed with CI list 822, according to an example embodiment. As shown in FIG. 12, browser window 802 is displayed by display 502, which includes a page 804 in which CI list 822 and conversations interface 1202 reside. Conversations interface 1202 enables the user to view a conversation that may be ongoing regarding CI 818, and to provide messages into the conversation.

Referring to step 1006 of FIG. 10, a plurality of messages associated with the commercial incentive from the friends of the user is displayed. For instance, as shown in FIG. 12, conversations interface 1202 displays a conversation 1212 that includes a first message 1208 and a second message 1210. In the example of FIG. 12, although two messages are shown included in conversation 1212 for ease of illustration, any number of further messages may be present. First and second messages 1208 and 1210 may be retrieved from one or more social networks associated with the user. For instance, friends of the user may be determined by friend determiner 310 of FIG. 11 as described above. Furthermore, friend determiner 310 may search the social network(s) for messages/conversations provided by the friends about the service, product, deal, coupon, etc., of CI 818 (e.g., by filtering messages of the social network(s) using search keywords associated with CI 818). The located messages may be displayed in conversation 1212 as message 1208, message 1210, etc. (which may be limited to a predetermined number of messages to be displayed). Images and/or identifiers for the friends that generated messages 1208 and 1210 may be displayed alongside messages 1208 and 1210 in conversation 1212.

In step 1008, a user interface element configured to enable the user to send a message to the friends of the user is displayed. For instance, as shown in FIG. 12, conversations interface 1202 may further include a message entry box 1204 and a UI element 1206. Message entry box 1204 enables a user to input a textual message regarding CI 818. By interacting with UI element 1206, the user is enabled to cause the input textual message be received in conversation 1212, and transmitted to the determined friends of the user. For instance, the input message may be sent to the friends in one or more social networks (e.g., as a message, a tweet, etc.). In an embodiment, conversation interface generator 1102 may access message generator 602 (FIG. 6) to send the message to the determined friends.

It is noted that conversations interface 1202 may optionally include a header that identifies conversations interface 1202 (e.g., “Conversations”, etc.).

### C. Example Embodiments for Saving Commercial Incentives

As described above, in an embodiment, a user may be enabled to save commercial incentives into a transportable/savable format. In this manner, the user may be able to more easily use/redeem a commercial incentive with the offering entity.

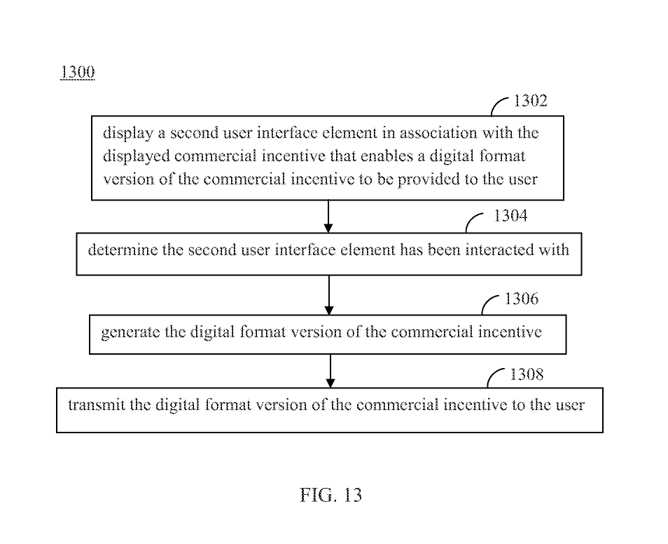

For instance, FIG. 13 shows a flowchart providing a process for generating a transportable version of a commercial incentive, according to an example embodiment. Flowchart 1300 is an example embodiment of flowchart 200 of FIG. 2. In an embodiment, CI socializing system 108 of FIG. 1 and CI socializing system 300 of FIG. 3 may each operate according to flowchart 1300. Further structural and operational embodiments will be apparent to persons skilled in the relevant art(s) based on the following description of flowchart 1300.

Flowchart 1300 begins with step 1302. In step 1302, a second user interface element is displayed in association with the displayed commercial incentive that enables a digital format version of the commercial incentive to be provided to the user. As described above with respect to step 202 of FIG. 2, CI 114 may be displayed in page 122. Furthermore, as described with respect to step 204 of FIG. 2, UI element 116 may be displayed in association with CI 114. Referring to FIG. 5, third UI element 512 is displayed in page 506 in association with CI 114. According to step 1302 of FIG. 13, UI element 512 may be configured to enable a digital format version of CI 114 to be provided to a user. In an embodiment, UI element 512 may have a corresponding label, such as the text “Digit Me” or other suitable label.

In step 1304, the second user interface element is determined to have been interacted with. UI element 512 may be configured in various ways, and the user may interact with UI element 512 in any suitable manner (e.g., as described with respect to UI element 116 elsewhere herein). An indication of the interaction with UI element 512 may be detected in browser window 504, and as shown in FIG. 1, may be transmitted from user device 102 to CI socializing system 108 as interaction indication 124. As shown in FIG. 3, page monitor 304 may receive interaction indication 124, and in response may generate a digitize instruction 324.

In step 1306, the digital format version of the commercial incentive is generated. As described above with respect to step 208 of FIG. 2, CI socializing system 108 may provide a transportable version of CI 114 to the user in response to UI element 116 being interacted with. Referring to FIG. 3, digital object generator 312 may receive digitize instruction 324 from page monitor 304, which instructs digital object generator 312 to generate a transportable/savable version of CI 114 for an identified user (the user having interacted with UI element 512 of FIG. 5). In an embodiment, digital object generator 312 may retrieve CI 114 from content serving module 302 (or directly from associated storage). As shown in FIG. 3, digital object generator 312 may generate a digital format version 326 of CI 114 that is savable (may be saved to storage at a user device of the user) and transportable (may be transmitted between entities, such as from user to user, if desired). For instance, digital object generator 312 may generate digital format version 326 as a PDF (portable document format) version of CI 114, a JPEG (joint photographic experts group) version of CI 114, a GIF (graphics interchange format) version of CI 114, a TIFF (tagged image file format) version of CI 114, or as other suitable transportable and savable object format. In this manner, the user may receive a copy of the CI 114 and will not lose access to CI 114 if the user navigates away from page 506 (FIG. 5) to another page. Digital object generator 312 may perform a conversion of the object format of CI 114 to the desired digital format version in a manner as would be known to persons skilled in the relevant art(s).

In an embodiment, digital format version 326 may be generated to include an appropriate visual code, such as a linear barcode, a matrix barcode (e.g., a QR (quick response) code), or other type of code, for CI 114. Using the visual code, users can redeem the offer provided by CI 114 by providing a paper version of digital format version 326 to a merchant for scanning, or by providing an electronic version of digital format version 326 displayed on a mobile device for scanning by the merchant.

In step 1308, the digital format version of the commercial incentive is transmitted to the user. In embodiments, digital object generator 326 may transmit digital format version 326 to the user identified in digitize instruction 324 in various ways, such as by attaching digital format version 326 to an email or a text message, or transmitting digital format version 326 to the user in another manner. For instance, an email address or text message identifier for the user may be determined from the user profile of the user, or from other source.

### D. Further Example Embodiments and Advantages

Embodiments create a new experience by allowing device users to save commercial incentives, such as coupons and deals, to share with friends, to view the commercial incentives later, and have conversations around the saved commercial incentives. In embodiments, users can view filtered conversations (e.g., social network messages, tweets, etc.) regarding commercial incentives and their associated products/services. Such embodiments can increase engagement across commercial incentives.

As such, some embodiments leverage a combination of commercial incentives, social network friends, and social network messages. Furthermore, the interests of users may be extracted based on their saved commercial incentives and messages. In an embodiment, an entity may analyze the commercial incentives saved by users, and their related messages, to improve targeting of products, services, advertisements, and commercial incentives to the users. This may increase revenue to such entities due to the increased engagement, and the increased time users may spend on a website that enables the functionality provided herein (e.g., a website that provides the functionality of the CI socializing systems and methods described herein).

### III. Example Computer Implementations

CI socializing system 108, CI socializing system 300, content serving module 302, page monitor 304, commercial incentive tracker 306, commercial incentive list display module 308, friend determiner 310, digital object generator 312, message generator 602, conversation interface generator 1102, flowchart 200, flowchart 400, flowchart 700, flowchart 900, flowchart 1000, flowchart 1300, and/or any further systems, sub-systems, and/or components disclosed herein may be implemented in hardware, software, firmware, or any combination thereof. For example, CI socializing system 108, CI socializing system 300, content serving module 302, page monitor 304, commercial incentive tracker 306, commercial incentive list display module 308, friend determiner 310, digital object generator 312, message generator 602, conversation interface generator 1102, flowchart 200, flowchart 400, flowchart 700, flowchart 900, flowchart 1000, and/or flowchart 1300 may be implemented as computer program code configured to be executed in one or more processors. Alternatively, CI socializing system 108, CI socializing system 300, content serving module 302, page monitor 304, commercial incentive tracker 306, commercial incentive list display module 308, friend determiner 310, digital object generator 312, message generator 602, conversation interface generator 1102, flowchart 200, flowchart 400, flowchart 700, flowchart 900, flowchart 1000, and/or flowchart 1300 may be implemented as hardware logic/electrical circuitry.

As described above, CI socializing systems may generate one or more user interfaces. For instance, CI socializing systems may enable user input to be provided from one or more of any type of user interface elements provided by a computing device, including a keyboard, a thumb wheel, a pointing device, a roller ball, a stick pointer, a touch sensitive display, any number of virtual interface elements, a voice recognition system, etc. Graphical user interfaces (GUI) may be displayed in a display of the computing device, such as in a browser window generated by a web browser, an application window, or in other window type mentioned elsewhere herein or otherwise known.

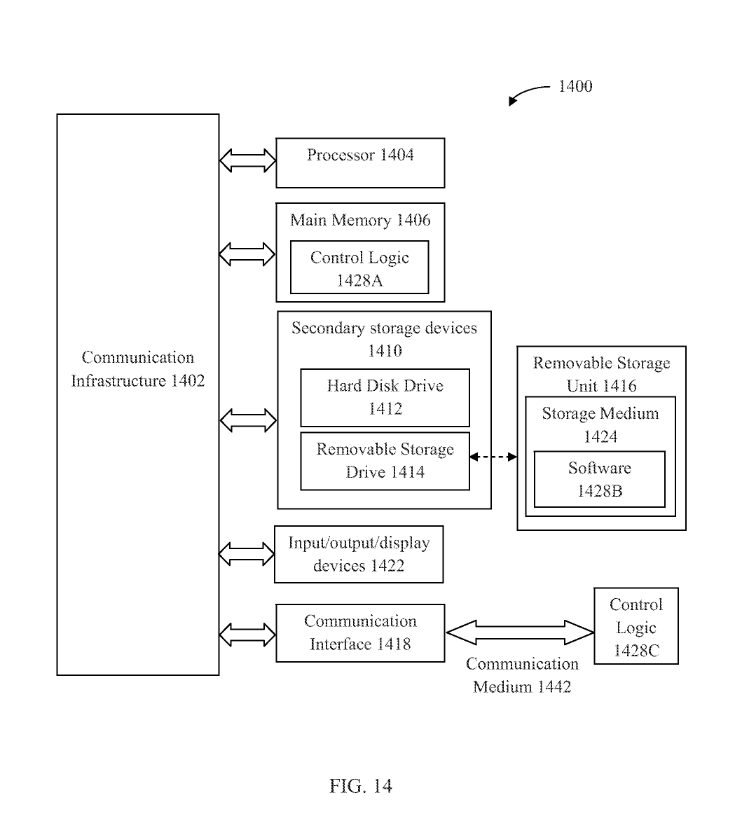

The embodiments described herein, including systems, methods/processes, and/or apparatuses, may be implemented using well known servers/computers, such as a computer 1400 shown in FIG. 14. For example, user device 102, server 104, and any of the sub-systems or components contained therein may be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

Computer 1400 includes one or more processors (also called central processing units, or CPUs), such as a processor 1404. Processor 1404 is connected to a communication infrastructure 1402, such as a communication bus. In some embodiments, processor 1404 can simultaneously operate multiple computing threads.

Computer 1400 also includes a primary or main memory 1406, such as random access memory (RAM). Main memory 1406 has stored therein control logic 1428A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1424 having stored therein computer software 1428B (control logic) and/or data. Removable storage unit 1416 represents a floppy disk, magnetic tape, compact disk, DVD, optical storage disk, or any other computer data storage device. Removable storage drive 1414 reads from and/or writes to removable storage unit 1416 in a well known manner.

Computer 1400 also includes input/output/display devices 1422, such as monitors, keyboards, pointing devices, etc.

Computer 1400 further includes a communication or network interface 1418. Communication interface 1418 enables computer 1400 to communicate with remote devices. For example, communication interface 1418 allows computer 1400 to communicate over communication networks or mediums 1442 (representing a form of a computer useable or readable medium), such as LANs, WANs, the Internet, etc. Network interface 1418 may interface with remote sites or networks via wired or wireless connections.

Control logic 1428C may be transmitted to and from computer 1400 via the communication medium 1442.

Any apparatus or manufacture comprising a computer useable or readable medium (e.g., a computer-readable storage or recording medium) having control logic (software) stored therein is referred to herein as a computer program product or program storage device. This includes, but is not limited to, computer 1400, main memory 1406, secondary storage devices 1410, and removable storage unit 1416. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media (computer-readable recording media) include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing CI socializing system 108, CI socializing system 300, content serving module 302, page monitor 304, commercial incentive tracker 306, commercial incentive list display module 308, friend determiner 310, digital object generator 312, message generator 602, conversation interface generator 1102, flowchart 200, flowchart 400, flowchart 700, flowchart 900, flowchart 1000, and/or flowchart 1300 (including any step of flowcharts 200, 400, 700, 900, 1000, and 1300), and/or further embodiments described herein. Embodiments of the invention are directed to computer program products comprising such logic (e.g., in the form of program code or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

The invention can work with software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
displaying a commercial incentive in a page displayed by a browser;
displaying a user interface element in association with the displayed commercial incentive that enables the commercial incentive to be saved;
determining the user interface element has been interacted with; and
saving an indication of the commercial incentive in a user profile of a user in response to said determining.

2. The method of claim 1, wherein said saving comprises:
saving a link associated with the commercial incentive; and
saving information regarding at least one of a deal or a coupon associated the commercial incentive.

3. The method of claim 1, wherein said saving comprises:
generating a message regarding the commercial incentive for a user account of a social network associated with the user; and
transmitting the message to at least one friend of the user indicated in the user account.

4. The method of claim 3, wherein the transmitted message is a tweet.

5. The method of claim 3, wherein said generating comprises:
including a tag in the message associated with the commercial incentive.

6. The method of claim 1, wherein said saving comprises:
saving the indication of the commercial incentive in a list of commercial incentives saved in the user profile.

7. The method of claim 6, further comprising:
displaying a second user interface element in association with the displayed commercial incentive that enables the list of commercial incentives to be displayed;
determining the second user interface element has been interacted with; and
displaying the list of commercial incentives.

8. The method of claim 7, wherein said displaying the list of commercial incentives comprises:
displaying information regarding the commercial incentive in the displayed list of commercial incentives;
determining at least one friend of the user having mentioned an aspect of the commercial incentive in a social network content stream; and
displaying an indication of the determined at least one friend in association with the displayed information regarding the commercial incentive.

9. The method of claim 8, wherein said displaying the list of commercial incentives comprises:
receiving an indication of an interaction with the displayed information regarding the commercial incentive; and
displaying a conversations interface in association with the displayed information regarding the commercial incentive, the conversations interface
displaying a plurality of messages associated with the commercial incentive at least from the friends of the user, and
including a third user interface element configured to enable the user to send a message to the friends of the user.

10. The method of claim 1, further comprising:
displaying a second user interface element in association with the displayed commercial incentive that enables a digital format version of the commercial incentive to be provided to the user;
determining the second user interface element has been interacted with;
generating the digital format version of the commercial incentive; and
transmitting the digital format version of the commercial incentive to the user.

11. A system, comprising:
a content serving module that provides a page to a computing device for display in a browser, the page including a commercial incentive and a user interface element positioned in association with the commercial incentive that enables the commercial incentive to be saved;
a page monitor that determines whether the user interface element displayed by the browser in the page has been interacted with; and
a commercial incentive tracker that saves an indication of the commercial incentive in a user profile of a user in response to a determination by the page monitor that the user interface element has been interacted with.

12. The system of claim 11, wherein the commercial incentive tracker saves the indication of the commercial incentive to include a link associated with the commercial incentive and information regarding at least one of a deal or a coupon associated the commercial incentive.

13. The system of claim 11, wherein the commercial incentive tracker comprises:
a message generator that generates a message regarding the commercial incentive for a user account of a social network associated with the user; and
the message is transmitted to at least one friend of the user indicated in the user account.

14. The system of claim 13, wherein the message generator includes a tag in the message associated with the commercial incentive.

15. The system of claim 11, wherein the commercial incentive tracker saves the indication of the commercial incentive in a list of commercial incentives saved in the user profile.

16. The system of claim 15, further including a commercial incentive list display module;
wherein the page further includes a second user interface element positioned in association with the displayed commercial incentive that enables the list of commercial incentives to be displayed;
wherein the page monitor determines whether the second user interface element has been interacted with; and
wherein the commercial incentive list display module enables the list of commercial incentives to be displayed in response to a determination by the page monitor that the second user interface element has been interacted with.

17. The system of claim 16, wherein the commercial incentive list display module enables information regarding the commercial incentive to be displayed in the displayed list of commercial incentives;
the system further comprising:
a friend determiner that determines at least one friend of the user having mentioned an aspect of the commercial incentive in a social network content stream; and
wherein commercial incentive list display module enables an indication of the determined at least one friend to be displayed in association with the displayed information regarding the commercial incentive.

18. The system of claim 17, wherein the page monitor determines whether the displayed information regarding the commercial incentive is interacted with;
wherein if the page monitor receives an indication of an interaction with the displayed information regarding the commercial incentive, the commercial incentive list display module enables a conversations interface to be displayed in association with the displayed information regarding the commercial incentive, the conversations interface including a plurality of messages associated with the commercial incentive sent by the friends of the user, and including a third user interface element configured to enable the user to send a message to the friends of the user.

19. The system of claim 11, further comprising:
a digital object generator;
wherein the page further includes a second user interface element positioned in association with the displayed commercial incentive that enables a digital format version of the commercial incentive to be provided to the user;
wherein the page monitor determines whether the second user interface element has been interacted with;
wherein the digital object generator generates the digital format version of the commercial incentive in response to a determination by the page monitor that the second user interface element has been interacted with; and
wherein the digital format version of the commercial incentive is transmitted to the user.

20. A method in a server, comprising:
receiving an indication that a user interacted with a first user interface element displayed in association with a commercial incentive displayed in a page at a user device;
saving an indication of the commercial incentive in a list of commercial incentives in response to the indication that the user interacted with the first user interface element;
receiving an indication that the user interacted with a second user interface element displayed in association with the commercial incentive; and
displaying the list of commercial incentives in response to the indication that the user interacted with the second user interface element.
